(19) United States
(12) Patent Application Publication
(10) Pub. No.: US 2009/0127281 A1
(43) Pub. Date: May 21, 2009

(54) Slap-On Resealable Closure

(76) Inventor: Charles P. Hickey, Pine Bluffs, WY (US)

Correspondence Address: BOYLE FREDRICKSON S.C., 840 North Plankinton Avenue, MILWAUKEE, WI, 53203, US

(21) Appl. No.: 12/272,374

(22) Filed: Nov. 17, 2008

Related U.S. Application Data
(60) Provisional application No. 60/988,523, filed on Nov. 16, 2007.

(51) Int. Cl. G01F 11/00; B67D 3/00

(52) U.S. Cl. 222/1; 222/528; 220/837; 222/530; 222/535

(57) ABSTRACT

The present invention is a closure capable of being applied to an existing container structure in order to form a releasable closure thereon. The closure includes base formed of a flexible material having an adhesive disposed on one side thereof in order to attach the closure to the exterior of a container. The closure also includes a flap secured at one end to the base opposite the adhesive which can be selectively adhered to the base over an opening formed in the base by a releasable adhesive disposed on the base or on the flap. The closure can conform to the shape of the exterior surface of the container to which it is secured and can be used with an aperture formed in the exterior of the container in alignment with the opening in the base to selectively dispense material from the interior of the container through the closure attached to the container.

### CROSS-REFERENCE TO RELATED APPLICATIONS

This application claims priority under 35 U.S.C. §119(e) from U.S. Provisional Application Ser. No. 60/988,523 filed on Nov. 16, 2007, which is expressly incorporated by reference herein in its entirety.

### FIELD OF THE INVENTION

The present invention relates to resealable closures and, more specifically, to a closure adapted to be positioned on existing containers to allow the containers to be opened and resealed as necessary.

### BACKGROUND OF THE INVENTION

A variety of containers have long been utilized to hold a variety of items, including food products, therein for transportation and resale. These containers can be formed of various materials, such as plastic, paper, and cardboard, among others. Some of these containers must be opened by severing or otherwise permanently deforming the container, such that the container cannot be re-closed. However, some item-holding containers are formed with mechanisms disposed thereon which enable the container to be opened and the contents of the containers to be dispensed therefrom. Certain containers of this type further include closure mechanisms that can be resealed to re-close the container after being initially opened. The majority of these closure devices include a pair of engageable sections that can be selectively disengaged from one another to provide access to the interior of the bag, and then re-engaged with one another to close the bag.

An improvement to closure devices of this type has been the inclusion of a sliding opener or zipper that is operable to mechanically engage and disengage the opposed portions of the closure device without the need for manually separating the opposed portions. The zipper device allows an individual to more easily open and close a bag as desired, while also providing a more reliable mechanism to effectively and securely engage the opposed sections of the closure device with one another to close the bag.

However, in order to utilize these types of sliding or zipper closure mechanisms with a container, such as a plastic bag, it has heretofore been necessary to include the closure mechanism within the original construction of the container. This greatly increases the complexity and cost of those containers that include these types of mechanisms.

Therefore, based on a number of container constructions which, for various reasons, do not allow for the easy inclusion of a resealable closure mechanism or device in the original construction of the container, it is desirable to develop a closure mechanism which can be retrofit on existing containers formed of various materials to allow the containers to be opened and closed utilizing a resealable closure device.

### SUMMARY OF THE INVENTION

According to one aspect of the present invention, a resealable closure device is provided that includes a base having an adhesive applied to one surface of the base, and a movable flap secured to the base over an opening formed in the base. The flap is affixed to the base at one end, and is releasably secured to the base along the remainder of the periphery of the flap. The base is secured to the exterior surface of a container holding a number of items therein, such that the opening in the base exposes a selected section of the container exterior though the base. The flap can be moved with respect to the base and the container, such that the section of the exterior of the container exposed through the base can be cut by a suitable cutting device to define an aperture in the exterior of the container. Alternatively, the section of the exterior of the container can already include the aperture formed in the container in some other manner. The aperture can be utilized to dispense items held within the interior of the container, and can be closed by the replacement of the flap on the base over the opening in the base and the aligned aperture in the container.

According to another aspect of the present invention, the closure can include a collapsible spout secured to the base between the base and the flap. The flap is secured to the base at a location spaced from the permanent attachment of the flap to the base, and can be extended when the flap is moved away from the base to form a dispensing aid to direct the material exiting the container through the closure.

According to still another aspect of the present invention, the base and the flap forming the closure are formed of a flexible material that allows the closure to conform and be secured to containers having non-planar exterior surfaces. Additionally, the flexible materials used to form the closure base and flap allow the closure to be formed in any of a number of conventional manufacturing processes, such that the closure can be readily constructed in a relatively inexpensive manner. Thus, with this construction the closure can be easily utilized to retrofit a number of different container structures with a resealable closure mechanism.

Numerous other aspects, features, and advantages of the present invention will be made apparent from the following detailed description taken together with the drawing figures.

### BRIEF DESCRIPTION OF THE DRAWINGS

The drawings illustrate the best mode currently contemplated as practicing the present invention.

In the drawings:

FIG. 1 is a perspective view of a first embodiment of the closure constructed according to the present invention in a closed position;

FIG. 2 is a perspective view of the closure of FIG. 1 in an opened position;

FIG. 3 is a perspective view of the closure of FIG. 1 secured to a container;

FIG. 4 is a perspective view of a second embodiment of the closure of FIG. 1 secured to a container;

FIG. 5 is a perspective view of a third embodiment of the closure of FIG. 1 secured to a container;

FIG. 6 is a perspective view of a fourth embodiment of the closure of FIG. 1 including a dispensing spout;

FIG. 7 is a perspective view of the spout of FIG. 6;

FIG. 8 is a perspective view of a fifth embodiment of the closure of FIG. 1 including a dispensing spout in a closed configuration; and

FIG. 9 is a perspective view of the closure of FIG. 8 with the dispensing spout in an opened configuration.

### DETAILED DESCRIPTION OF THE INVENTION

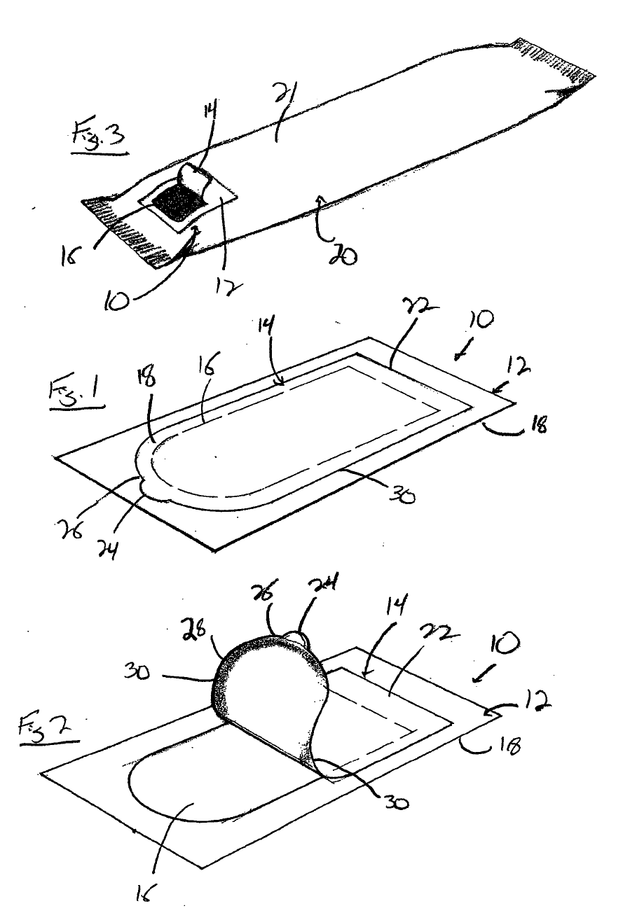

With reference now to the drawing figures in which like reference numerals designate like parts throughout the disclosure, a closure adapted to be positioned on a container to provide a recloseable opening in the container is illustrated generally at 10 in FIGS. 1 and 2. The closure 10 includes a base 12 to which is secured a sealing flap 14. The flap 14 is positioned on the base 12 over an opening 16 formed in the base 12, such that the flap 14 has a size sufficient to completely cover the opening 16.

The base 12 is formed of a flexible material, such as a thin plastic material, and can be formed to have any desired shape in order to accommodate the desired shape and size for the opening 16 formed therein. The base 12 also includes an adhesive 18 applied to the base 12 opposite the flap 14. The adhesive 18 is applied over the entire surface of the base 12 in order to enable the base 12 to securely adhere to the exterior surface 21 of a container 20. Due to the flexible nature of the material forming the base 12, the base 12 can readily conform to the shape of the exterior surface 21 of the container 20, allowing the closure 10 including the base 12 to be utilized with containers 20 having generally non-planar exterior surfaces 21.

The flap 14 is also formed of a flexible material, such as a thin plastic material, and can be formed separately from or integrally with the material forming the base 12. The shape of a flap 14 and generally conforms to the shape of the opening 16 formed within the base 12. However, the flap 14 is formed to be slightly larger in area than the opening 16, such that the flap 14 can completely cover the entire area defined by the opening 16. The flap 14 is securely attached to the base 12 in a non-releasable manner at a first end 22 of the flap 14. This attachment of the first end 22 to the base 12 can be accomplished in any suitable manner, such as by integrally forming the first and 22 with the base 12, or by heat-sealing, adhering or otherwise fixing the first end 22 to the base 12. The attachment of the first and 22 to the base 12 prevents the flap 14 from being inadvertently disengaged from the base 12 in rendering the closure 10 inoperable.

Opposite the first and 22, the flap 14 preferably includes a tab 24 disposed at a second end 26 of the flap 14 that extends outwardly from the flap 14. The tab 24 functions as a grasping point for the flap 14 such that an individual can grasp of the tab 24 in order to move the flap 14 between open and closed positions with regard to the base 12.

Between the first end 22 and the tab 24 on the second end 26, the flap 14 includes an adhesive layer 28 positioned around the peripheral edge 30 of the flap 14 with the exception of the tab 24, as the tab 24 is required to be una&ered to the base 16. Alternatively, the adhesive layer 28 can be positioned on the base 12 opposite the adhesive 18 in alignment with the periphery of the flap 14. The adhesive layer 28 is formed from an adhesive that has the ability to hold the flap 14 in a closed position with regard to the base 12 over the opening 16, and to enable the flap 14 to be removed from the base 12 to expose the opening 16 and subsequently reattached to the base 12 over the opening 16. Thus, the adhesive forming the adhesive layer 28 is a releasable adhesive that allows the flap 14 to be displaced from and reattached to the base 12 multiple times to enable items to be dispensed from the container 22 which they closure 10 is secured on multiple separate occasions.

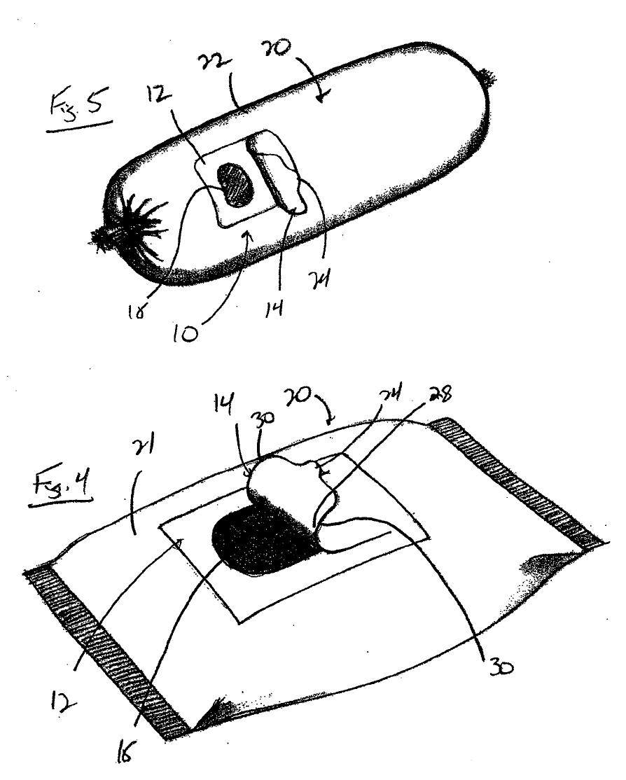

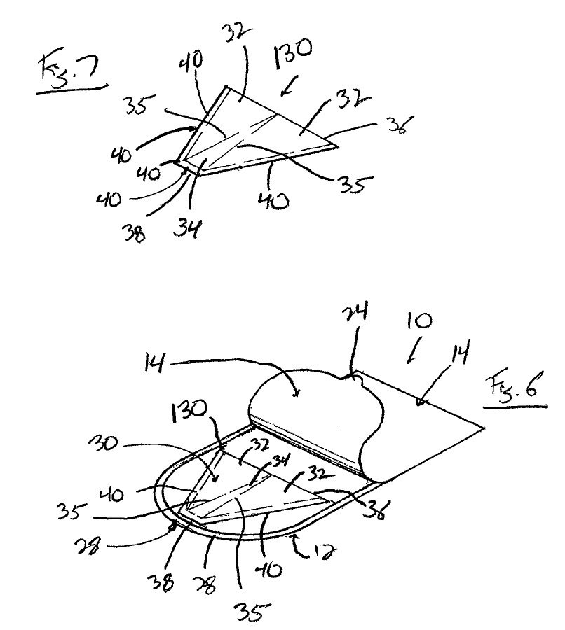

Looking now at FIGS. 3-5, the closure 10 formed according to the present invention is illustrated as being secured to containers 20 having various shapes and formed of various materials. In each case, the base 12 of the closure 10 is affixed to an exterior surface 21 of the container 20 to provide a reclosable opening 16 through which the material or items held within the container 20 can be selectively dispensed from the container 20. As seen in FIGS. 3-5, the configurations for the particular closures 10 to be utilized with specific containers 20 can be modified as necessary to accommodate the type of material held within the container 20, the shape of a container 20, and/or the type of material utilized to form the container 20. As a result, they closure 10 can be utilized on containers 20 having virtually any shape and holding any type of material therein that are formed of virtually any type of material, including plastics, paper and cardboard.

To assist in dispensing the materials from within certain types of containers 20, the closure 10 can be provided with a spout 130 the shown in FIGS. 6-9. The spout 130 is formed of a generally flexible or foldable material, such as a thin plastic or paperboard material, and includes a pair of side sections 32 joined by a center section 34, which preferably can be formed to be expandable. The side sections 32 and the center section 34 are also connected along flexible joints or hinges 35, which can be created directly in the material forming the spout 130, or separately formed and/or secured between the respective section 32 and 34. The side sections 32 and center section 34 are preferably integrally formed with one another, but can be formed of a separate pieces and/or materials that are subsequently joined to one another in any suitable manner, such as by an adhesive, to form the spout 130. The construction of the side sections 32 and center section 34 to form a spout 130 provides the spout 130 with a wide dispensing end 36 and a narrow end 38.

To secure the spout 130 to the closure 10, the side sections 32 each include an adhesive layer 40 applied to an outer edge 42 of each side section 32 located generally opposite the center section 34. In addition, the center section 34 includes an adhesive layer 40 disposed along the narrow end 38 of the spout 130. The adhesive layer 40 can securely affixed to the spout 30 to the base 12 in a position where the spout 130 is disposed between the base 12 and the flap 14 when the closure 10 is in the closed position. The spout 130 can be preassembled with the closure 10 to form an integral part thereof, or can be formed as a separate component that can selectively be secured to the base 12 of the closure 10 by an individual, if desired.

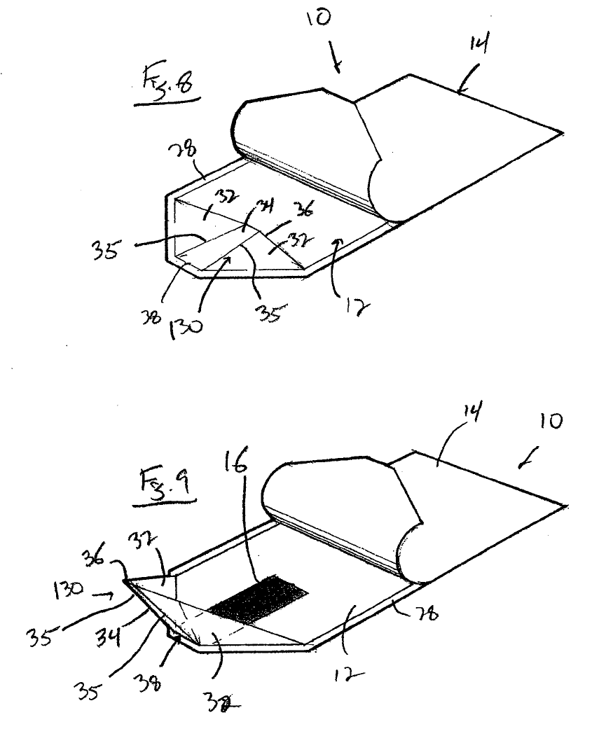

In the embodiments of the closure 10 where the closure 10 includes the spout 130, the opening 16 formed in the base 12 is preferably formed to have an area that can be completely covered by the spout 130 when the spout 130 is in the closed position, as best shown in FIGS. 7 and 8. In this position, both the spout 130 and the flap 14 operate to cover the opening 16 and prevent the passage of any items or material through the opening 16. However, when the flap 14 and spout 130 have been moved to the open positions, shown in FIG. 9, material can be dispensed through the opening 16 in the base 12 while being directed by the orientation of the spout 30.

When utilizing the closure 10, initially a backing strip or release liner (not shown) is removed from the base 12 to expose the adhesive 18. The base 12 is then positioned on an exterior surface 21 of the container such that the adhesive 18 securely affixes the base 12 to the container 20. Once the closure 10 is secured to the container 20, an individual grasps the tab 24 to move the flap 14 to the open position to expose the exterior surface of the container through the opening 16 in the base 12. In one method, where there is not already an opening present within the exterior surface 21 of the container 10, the individual may utilize any suitable cutting device (not shown) to form the aperture in the exterior surface 21 of the container 20 in alignment with the opening 16 in the base 12. Alternatively, the base 12 can be positioned on the container 20 such that the opening 16 is positioned in line with a predetermined aperture located on the container 20, such that no cutting device is necessary to form the aperture.

Once the aperture is formed in the exterior surface 21 of the container 20, the material or items held within the container 20 can be dispensed through the aperture and the opening 16. When it is desired to reclose the container 20, the flap 14 is repositioned on the base 12 over the opening 16 such that the adhesive 28 on the flap 14 contacts and secures the flap 14 to the base 12 in a position where the flap 14 entirely covers the opening 16 in the base 12 and aperture in the container 20. Subsequently, the closure 10 can then be reopened to dispense additional material from the container 20 by grasping the tab 24 on the flap 14 and pulling the flap 14 away from the base 12 to the open position.

In those embodiments including the spout 130, if the spout 130 is provided separately from the closure 10, the spout 130 can first be affixed to the base 12 over at least a portion of the opening 16 at a location where the spout 130 is disposed between the base 12 and the flap 14 when the flap 14 is in the closed position. After the closure 10 is secured to the exterior surface 21 of the container 20, and after the aperture is formed in the container 20, if necessary, when it is desired to dispense material from the container 20, the central section 34 of the spout 130 is pulled away from the opening 16 to enable the center section 34 and side sections 32 to form the angular spout 130. After the desired amount of material has been dispensed from the container 20, the side sections 32 are deflected inwardly to collapse the spout 130 into a retracted position and can be covered by the flap 14 when the flap 14 is moved to the closed position.

Various alternatives are contemplated as being within the scope of the following claims particularly pointing out and distinctly claiming the subject matter regarded as the invention.

What is claimed is:

1. A resealable closure adapted to be secured to the exterior of a container holding a number of items therein, the closure comprising:
a) a base adapted to be affixed to the exterior surface of a container and an opening defined in the base; and
b) a flap having a first end fixed to the base and including an resealable closing mechanism disposed around the periphery of the flap that is releasably engageable with the base to selectively hold the flap in position on the base over the opening.

2. The closure of claim 1 wherein the base including a permanent adhesive disposed along one side of the base

3. The closure of claim 1 wherein the resealable closing mechanism is a resealable adhesive.

4. The closure of claim 1 further comprising a tab disposed on a second end of the flap opposite the first end.

5. The closure of claim 1 wherein the base and the flap are each formed of a flexible material.

6. The closure of claim 5 wherein the base and the flap are integrally formed with one another.

7. The closure of claim 1 further comprising a spout secured to the base adjacent the opening in the base.

8. The closure of claim 7 wherein the spout is positioned between the base and the flap.

9. A method for dispensing material from a container, the method comprising the steps of:
a) providing a closure comprising a base adapted to be affixed to the exterior surface of a container and an opening defined in the base, and a flap having a first end fixed to the base and including an resealable closing mechanism disposed around the periphery of the flap that is releasably engageable with the base to selectively hold the flap in position on the base over the opening;
b) securing the base to the exterior surface of the container; and
c) disengaging the flap from the base to expose the opening in the base.

10. The method of claim 9 wherein the step of securing the base to the exterior surface of the container comprises adhesively securing the base to the container.

11. The method of claim 9 further comprising the step of forming an aperture in the exterior surface of the container after securing the base.

12. The method of claim 11 wherein the step of forming the aperture in the container comprises:
a) disengaging the flap from the base to expose the opening in the base; and
b) cutting a section out of the exterior surface of the container.

13. The method of claim 9 wherein the closure further comprises a spout secured to the base, and wherein the method further comprises the step of dispensing material from within the container through the spout.

14. The method of claim 14 wherein the step of dispensing material comprises:
a) extending the spout from the base; and
b) pouring the material through the spout in the extended position.

15. The method of claim 14 further comprising the steps of:
a) moving the spout into the retracted position after pouring the material through the spout; and
b) replacing the flap in engagement with the base over the aperture in the base.
